(19) United States
(12) Patent Application Publication
(10) Pub. No.: US 2021/0016206 A1
(43) Pub. Date: Jan. 21, 2021

(54) MODULAR FILTRATION SYSTEM

(71) Applicant: Casey William Field, Colorado Springs, CO (US)

(72) Inventor: Casey William Field, Colorado Springs, CO (US)

(21) Appl. No.: 16/793,426

(22) Filed: Feb. 18, 2020

Related U.S. Application Data
(60) Provisional application No. 62/875,711, filed on Jul. 18, 2019.

(51) Int. Cl. B01D 25/02; B01D 46/54; B01D 25/00; B01D 63/08

(52) U.S. Cl. CPC B01D 25/02; B01D 46/543; B01D 2313/02; B01D 63/082; B01D 2313/54; B01D 25/002

(57) ABSTRACT

A filtration vessel, having within constituent filter media is formed using plastic injection molding to meet the interior specifications of a high-pressure filtration encasement system while remaining a separate replaceable component. The encasement system supports and encases walls of the filtration vessel enabling the vessel to be designed with sufficient strength and resiliency to form a seal and constrain filter media prior to and after use without necessitating construction to endure independent high-pressure operations. The bottom or base of the vessel includes a plurality of holes through which the filtrate may flow. Interposed between the base of the vessel and the filter media is a semi-permeable barrier imbedded into the injection molded walls and base of the vessel. The barrier prevents residue from contaminating the filtrate.

### RELATED APPLICATION

The present application relates to and claims the benefit of priority to United States Provisional Patent Application No. 62/875,711 filed 18 Jul. 2019 which is hereby incorporated by reference in its entirety for all purposes as if fully set forth herein.

### BACKGROUND OF THE INVENTION

### Field of the Invention

Embodiments of the present invention relate, in general, to filtration systems and more particularly to a modular, configurable filtration system used in high pressure environments.

### Relevant Background

Filtration allows saturated extractions to become refined into a higher quality product. Filtration is any of various mechanical, physical or biological operations that separates solids from fluids (liquids or gases) by adding a medium through which only the fluid can pass. The fluid that passes through such a medium is called the filtrate. In physical filters oversize solids in the fluid are retained mechanically and in biological filters particulates are trapped and ingested while bound metabolites are retained and removed. In most instances, however, the separation is not complete; solids will be contaminated with some fluid and conversely filtrate will contain fine particles (depending on the pore size, filter thickness and biological activity).

Filtration occurs both in nature and in engineered systems; there are biological, geological, and industrial forms of filtration. For example, in animals (including humans), renal filtration removes waste from the blood, and in water treatment and sewage treatment, undesirable constituents are removed by absorption into a biological film grown on or in the filter medium, as in slow sand filtration.

There are many different methods of engineered filtration; all aim to attain the separation of substances. Separation is achieved by some form of interaction between the substance or objects to be removed and the filter. The substance that is to pass through the filter is a fluid, i.e. a liquid or gas but the methods of filtration vary depending on the location of the targeted material, i.e. whether it is dissolved in the fluid phase or suspended as a solid. In both instances the filter media is a fundamental driver of the resulting filtrate.

Two main types of filter media are employed in laboratories: a surface filter, a solid sieve which traps the solid particles, with or without the aid of filter paper; and a depth filter, a bed of granular material which retains the solid particles as it passes (e.g. sand filter). The first type allows the solid particles, i.e. the residue, to be collected intact while the second type does not. However, a depth filter is less prone to clogging due to the greater surface area where the particles can be trapped. Also, when the solid particles are very fine, it is often cheaper and easier to discard the contaminated granules than to clean the solid sieve. In some instances, the two methodology is combined to capture the advantages of both systems.

Fluids undergoing filtration flow through the filter and related filtration media from high pressure to low. In many instances, gravity is the source of differential pressure but in other instances compressed air and/or pumps are using to create local pressure gradients though which the fluid, or material to be filtered, passes. In high pressure filtration environments, filtration setups use separate vessels, usually of stainless steel, that are connected externally inline to the existing extraction equipment. These units are reused and manually packed with filter media each run. In such a methodology the filter media must be placed into the canister and, correspondingly, replaced once the filter media has become saturated. The filtrate which results vary based on a lack of consistent filter material and consistent filter processes. For example, in many instances, filter paper is placed into the filter vessel on the upper surface of a base strainer plate. In some cases, a weighted ring is used to assist in holding it in place. Unfortunately, a lack of a sufficient seal between the filter media, filter paper results in granulated media passing around the edge of the filter paper contaminating the filtrate.

A need exists for a preexisting packaged filtration system for use during high pressure filtration. There is also a need for a highly reliable and consistent filtration mechanism by which the filtration media of a depth media and the filter barrier of a surface filter are combined into a single use, disposable system. These and other deficiencies of the prior art are addressed and resolved by one or more embodiments of the present invention.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

A modular filtration vessel providing differing degrees of filtrate remediation is hereafter disclosed by way of example. The filtration system of the present invention allows a saturated extraction to be consistently refined into a higher quality product while allowing and end user to select a pre-packaged or pre-configured filter tailored to a desired outcome (by way of different filtration media depending on unwanted saturation). Upon recognition that filtration processes have ceased, or filtrate flow has significantly diminished indicating that the filter media is exhausted, the entirety of the vessel, inclusive of the exhausted filer media, can be removed and replaced with a new, preconfigured vessel and filter media.

In one embodiment a fluid extraction apparatus of the present invention is comprised of a removable vessel having a wall with an inner wall surface and an outer wall surface. Both of the walls are substantially parallel to a common central axis forming a cylindrical shape. The cylinder includes a first end, a second end and a base perpendicular to the common axis and coupled to the vessel at the second end.

The apparatus also includes a flange extending circumferentially from an outer surface of the outer wall of the vessel adjacent to the first end. The flange incorporates a semi-rigid perturbance or gasket extending outward from the flange parallel to the central axis.

The perturbance located on the flange of the vessel is, in one embodiment, configured to engage a first channel present in a first ferrule and a second channel present in a second ferrule. A clamp is thereafter configured to engage the first ferrule and the second ferrule compressing the perturbance within the channels respectively thereby forming a seal. In another embodiment the perturbance extends from unilaterally from the flange.

Positioned at and covering the base within the vessel is a semipermeable barrier. A portion of the semipermeable membrane is interposed between the base and the annular surface at the second end of the vessel to prevent residue from contaminating the filtrate. The base is coupled to an annular surface between the inner wall surface and the outer wall surface at the second end and includes a plurality of voids configured to allow unimpeded transmission of a filtrate from an interior of the vessel and through the semipermeable barrier.

The vessel of the present invention is configured to accept one or more constituent filter media components so as to reside within the vessel and between an upper surface of the semipermeable barrier proximate to the second end and the first end. The semipermeable barrier and filter media are adapted to accommodate a filtrate therethrough. In a different embodiment, constituent filter media components reside within the vessel and are positioned between an upper surface of the semipermeable barrier and the first end said semipermeable barrier, the filter media being adapted to accommodate a filtrate therethrough.

The semipermeable barrier can adopt several different configurations. In one embodiment the barrier is a membrane while in another it is a filter. The barrier may be planar, circular, conical, plant based, metallurgical based or made of synthetic material. In each case the base and the wall of the vessel form a unified structure and a portion of the semipermeable barrier is integrated into the unified structure to prevent residue from contaminating the filtrate.

Another embodiment of the present invention a system for fluid extraction, includes a removable vessel having a wall with an inner wall surface and an outer wall surface. Again, both wall surfaces are substantially parallel to a common central axis forming a cylinder. The cylinder also includes a first end, a second end and a base perpendicular to the common axis which is coupled to the vessel at the second end. The vessel further includes a flange extending circumferentially from an outer surface of the outer wall adjacent to the first end and wherein the flange includes a semi-rigid perturbance extending outward from the flange parallel to the central axis.

The system also includes a housing or encasement system having a housing inner wall and a housing ferrule. The housing is sized to accept the removable vessel such that the housing inner wall is proximate to the outer wall surface of the vessel. The housing ferrule is also adjacent to and supports a lower surface of the flange of the vessel and is configured to accept a portion of the semi-rigid perturbance. An intake column having an intake column ferrule adjacent to an upper surface of the flange of the vessel is also part of the system and is configured to accept a second, upper, portion of the semi-rigid perturbance. Finally, a clamp forms the last component of the system which is configured to compress the intake column ferrule, the housing ferrule and the flange of the vessel to form a seal.

The vessel also includes a semipermeable barrier positioned at, and covering, the base within the vessel. A portion of the semipermeable membrane is interposed between the base and the annular surface at the second end of the vessel. The base and the wall of the vessel form a unified structure within which the portion of the semipermeable barrier is integrated.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 presents a high-level system diagram of a filtration and extraction system utilizing one or more filtration vessels according to one embodiment of the present invention;

FIG. 2 shows a front perspective view of a filtration vessel, according to one embodiment of the present invention;

FIG. 3 shows a detailed view of the integration of the base, semipermeable barrier and vessel walls;

FIG. 4 shows a cutaway view of one embodiment of a filtration vessel of the present invention in association with an encasement system and intake channel.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

A filtration vessel, having within constituent filter media, is introduced into a high-pressure filtration encasement. The vessel of the present invention is, in one embodiment, formed using plastic injection molding to meet the interior specifications of a high-pressure filtration encasement system while remaining a separate replaceable component. The encasement system supports and encases walls of the filtration vessel enabling the vessel to be designed with sufficient strength and resiliency to constrain filter media prior to and after use without necessitating construction to endure independent high-pressure operations. The bottom or base of the vessel includes a plurality of holes or voids through which the filtrate may flow. Interposed between the base of the vessel and the filter media held with the vessel is a semi-permeable barrier imbedded into the injection molded walls and base of the vessel. The barrier prevents any granulated filter media or extract from passing thought the filter vessel into the encasement system contaminating the filtrate. The present invention provides an insertable vessel which can be inserted into an encasement system and thereafter removed and replaced. In one embodiment, prepackaged filter vessels or cannisters can be designed for different grades of filtrate and for different filtration conditions.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Like numbers refer to like elements throughout. In the figures, the sizes of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity. The following terms are defined to aid clarity in their use with respect to the present invention.

A semipermeable membrane is understood to be a thin biological sheet or sheets of material that allow certain molecules to pass through more easily than others. The molecules tend to move from areas of high concentration to areas of low concentration—a process called diffusion. Semipermeable membranes can be both biological and artificial. Artificial semipermeable membranes include a variety of material designed for the purposes of filtration, such as those used in reverse osmosis, which allows only water to pass.

A semipermeable barrier may also be a filter. A filter is a mechanical system for separating different material. Many items are both membranes and filters, but neither category completely includes the other. For example, a balloon is a membrane, but not a filter. A size exclusion column is a filter, but not a membrane. A sheet of cellulose is a membrane which is often used as a filter. For the purpose of the present invention a semipermeable barrier may be a membrane or mechanical filter. Both are contemplated to be within the scope of the present invention.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

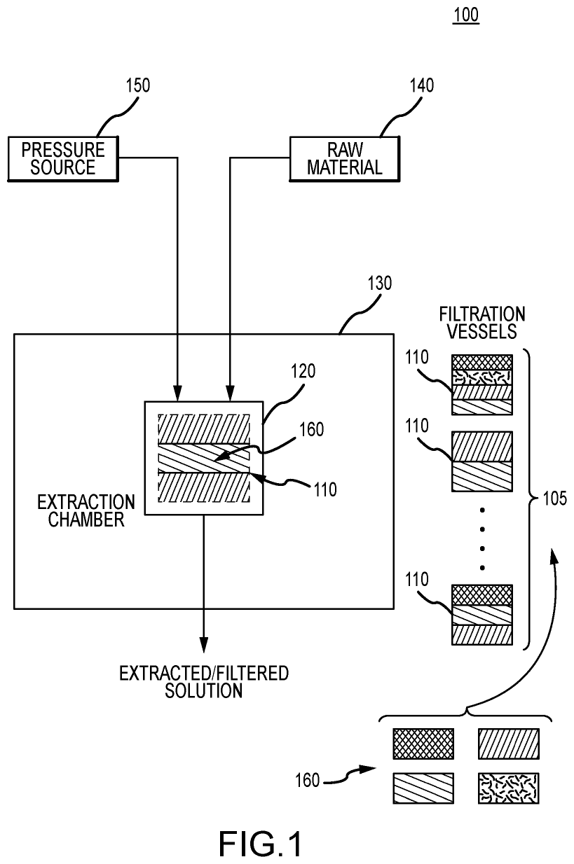

FIG. 1 presents a high-level system diagram of a filtration and extraction system 100 utilizing one or more of a plurality of filtration vessels 105 of the present invention. A substantially cylindrical vessel 110 having a first end and a second end and an interior portion suitable for housing various constituent types of filter media 160 in incorporated into and encasement system 120 in an extraction/filtration apparatus. In one embodiment of the present invention, the vessel 110 of the present invention is substantially cylindrical and is inserted into and encased by a high-pressure encasement chamber 130. The vessel 110 can be configured to incorporate within its interior various constituent types of filter media depending on the functional demands of the extraction system.

Raw material 140 designated for filtration or refinement is directed to an intake channel. The intake channel is further coupled to the first end or upper surface of the vessel within the encasement system. A pressure source 150 drives the raw material through the filter media housed within the vessel 110 delivering the filtered solution or filtrate to a repository outside the encasement system 130. As the raw material 140 flows through the filter material housed by the vessel 110 the filter material binds with impurities and filtride until becoming saturated. Upon saturation of the filter media in the vessel 110 the used filter material/vessel is removed and replaced with a new, preconfigured vessel having new unused filter material. Once inserted into the encasement system, pressure is restored, and filtration reinitiated.

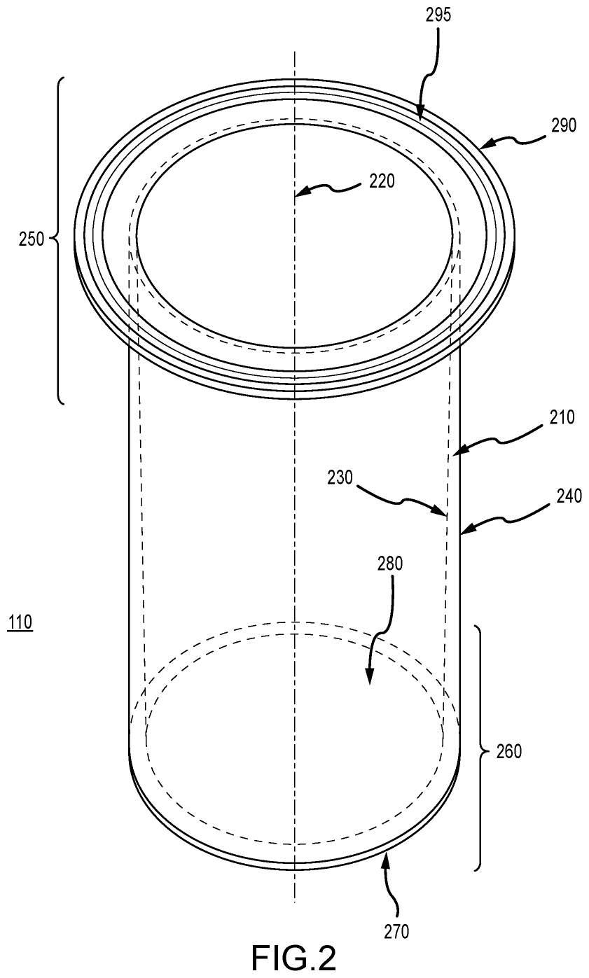

FIG. 2 is a front perspective view of a filtration vessel 110 according to one embodiment of the present invention. A cylindrical chamber suitable for housing various constituent parts of filter media is encased by a wall 210 substantially parallel to a central axis 220 having an inner wall surface 230 and an outer wall surface 240. The vessel 110 is bounded by an upper, first end 250 and a lower, second end 260. While the description herein presents the invention in a cylindrical format, one of reasonable skill in the relevant art will recognize that other cross-sectional shapes are equally applicable and indeed contemplated.

A segmented base 270 configured to enable filtrate to flow therethrough is integrated with the wall at the second end 260. Positioned above and covering an upper surface of the base 270 is a semipermeable barrier 280. Edges of the semipermeable barrier 280 are integrated and interposed between the base 270 and an annular surface between the inner wall surface 230 and the outer wall surface 240 at the second end 260. In one embodiment of the present invention the vessel wall, base and semipermeable barrier are formed in a single process making a unified, seamless juncture eliminating any possibility that a residue can bypass the barrier and contaminate the filtrate. While in this depiction the barrier is circular, the shape of the barrier can be modified to conform with the shape of the vessel. The filter may be planar, conical, domed, angular or any other shape suitable to prevent residue or contaminants from exiting the vessel and into the filtrate. The barrier may be composed of a plant, animal, biological, metallurgical or synthetic based material.

The vessel also includes a flange 290 extending circumferentially from the outer surface of the outer wall 240 of the vessel 110 adjacent to the first end 250. The flange 290 further includes a semi-rigid perturbance 295 extending outward from the flange parallel to the central axis 220. In one embodiment the perturbance is symmetrical extending in both directions above and below the flange. In other embodiments the perturbance asymmetrical extending either above or below the flange. The perturbance is semi-rigid and which, up depression, is elastically deformable.

In one embodiment of the present invention the vessel walls, base and flange are formed from plastic material consisting of a wide range of synthetic or semi-synthetic organic compounds that are malleable and can be molded into a solid object. In one instance the material is synthetic derived from petrochemicals however other variants from renewable materials such as polylactic acids is also contemplated. In one variant of the present invention thermoplastics such as polyethylene, polypropylene, polystyrene, and polyvinyl chloride are used while in other variants of the present invention thermosets are using making the thermosetting process irreversible.

In other embodiments the vessel walls, flange, and base may be formed from metallic material such as stainless steel, aluminum or the like. One of reasonable skill in the relevant art of material science will recognize that many suitable materials exist that can be used for forming the vessel as described herein. These and other implementation methodologies can be used for forming the vessel of the present invention. Such means of implementation are known within the art and the specifics of their application within the context of the present invention will be readily apparent to one of ordinary skill in the relevant art in light of this specification.

Similarly, the perturbance associated with the flange of the first end can be formed from any elastically deformable material akin to plastic and rubber. In another embodiment the perturbance and flange are crafted from the same material having sufficient rigidity to support the vessel yet flexible enough to form a seal when compressed between opposing ferrules.

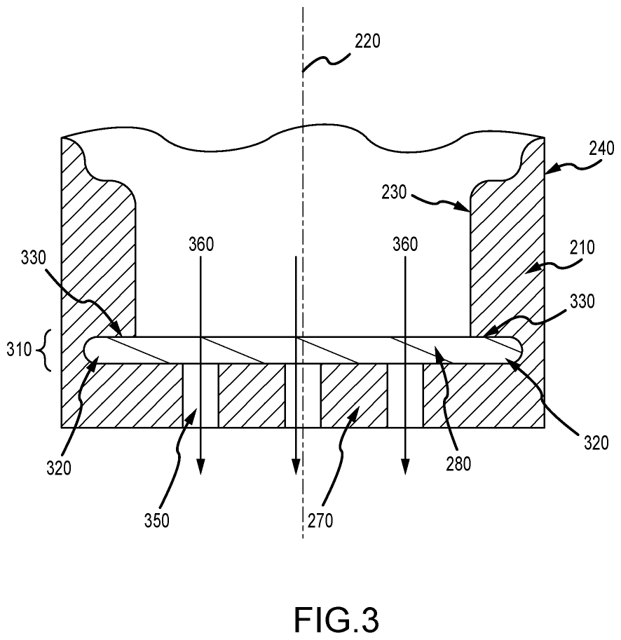

FIG. 3 is a detailed side cutaway view of the integration of the semipermeable barrier 280 with base 270 and vessel wall juncture 310. According to one embodiment of the present invention, edges 320 of the semipermeable barrier 280 are integrated into the juncture 330 between the walls of the vessel and the base to form unified connection. A lack of such a unified juncture results in impurities and residue bypassing the barrier and the seam or point of interaction between the barrier and wall. While the base provides holes 350 or voids in its structure by which filtrate 360 may flow after it passes through the barrier, residue is prevented from by passing the barrier at its edges. Different shapes and material composition of the barrier can be utilized by the present invention while maintaining the integrated and unified construction described above.

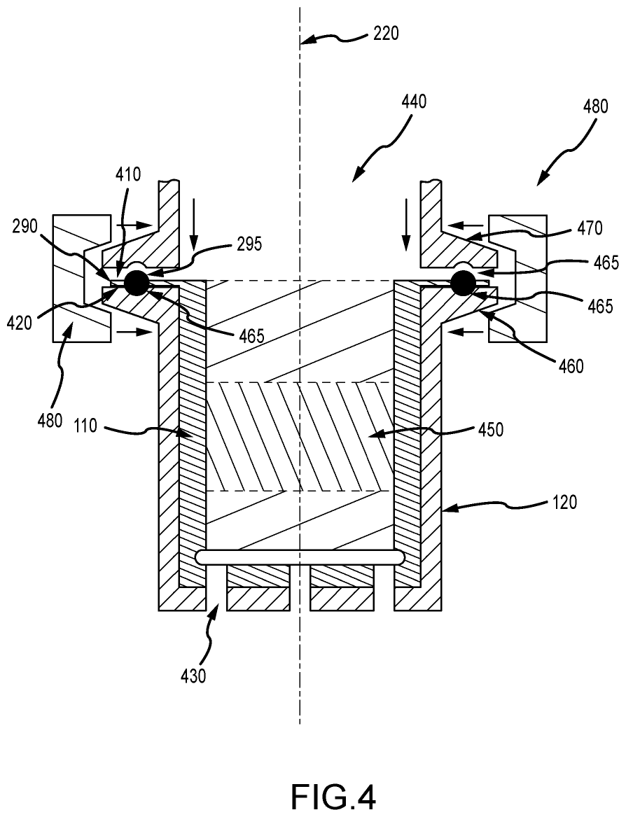

A front cut-away view of the vessel and associated encasement system is presented in FIG. 4. As shown a filtration vessel 110 according to one embodiment of the present invention, is inserted in and encased by an encasement system. As previously described, the vessel is, in one embodiment, cylindrical having a wall with an inner surface parallel to a common central axis 220. The first or upper end of the vessel includes a flange 290 extending circumferentially from the outer surface of the wall. The flange 290 includes an upper 410 and lower surface 420 substantially perpendicular to the central axis 220. The flange also includes a perturbance 295 extending outward from the upper and lower surface of the flange, parallel to the central axis. In one embodiment the perturbance is formed of a semi-ridge elastically deformable material.

The bottom of the encasement system includes drains 430 or voids through which filtrate can flow. In other embodiments the vessel encasement system is incorporated into a pressurized environment such that the base of the vessel is supported yet the entirety of the vessel and encasement system exists in a pressurized environment.

FIG. 4 further depicts an intake channel 440 through which raw material is introduced to the first end of the vessel under pressure. The filer media 160, contained within the vessel, interacts with the raw material to remove any impurities resulting in a filtrate collected at the second end or base of the vessel.

The depicted encasement system includes a lower ferrule 460 on which the flange 290 of the vessel 110 rests. A channel 465 within the lower ferrule 460 is configured to accept the perturbance 295 extending from the lower surface 420 of the flange 290. Similarly, the intake channel includes an opposing or upper ferrule 470 having a channel 465 configured to accept the perturbance 295 extending from the upper surface 410 of the flange 290.

A clamp 480 extends around the lower ferrule 460 of the encasement system 120 and the upper ferrule 470 of the intake channel 440. As the clamp is drawn toward the central axis 220 the angular surfaces of each ferrule and the clamp interact to compress the upper 470 and lower 460 ferrules together. Interposed between the upper ferrule 470 and the lower ferrule 460 is the flange 290. The flange 290 and the perturbance 295 in the flange are drawn within the channel 465 present in the upper and lower ferrule. As the ferrules 460, 470 are compressed together the interaction of the perturbance 295 and respective channels 465 form a seal.

The present invention enhances high pressure filtrate extraction by increasing throughput. High pressure extraction of filtrate requires a combination of filter media constituents to achieve a desired degree of purity. Prior to the introduction of the present invention, a high-pressure filter media canister or encasement was configured with the filter media and placed into service until the media became saturated. Upon throughput being impeded by residue binding with the filter media, the system would be shut down and the used filter media removed from the canister. The cannister would be cleaned, inspected and a set to receive a new set of filter media. Once a new configuration of fresh filter media had been installed the cannister placed under pressure and extraction resumed.

The inefficiencies of the prior art are addressed by the removable containerized filter media vessel of the present invention. A plurality of vessels can be preconfigured with various combinations of filter media. As the throughput of the extraction process begins to diminish, pressure can be released, the encasement chamber opened, and the used filtration vessel removed. A new filtration vessel, preconfigured with fresh filter media, can be quickly reinserted into the encasement chamber. A seal can be quickly formed, and extraction resumed. The removable and replaceable filtration vessels of the present invention can be preconfigured to quickly address differing degrees of filtrate purity. And by using replaceable filtration vessels the operational status of the high pressure extraction system is maximized.

While the invention has been particularly shown and described with reference to embodiments, it will be understood by those skilled in the art that various other changes in the form and details may be made without departing from the spirit and scope of the invention. While the principles of the present invention in conjunction with a replaceable filtration vessel have been described herein, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

1. A fluid extraction apparatus, comprising:
a cylindrical wall with an inner wall surface and an outer wall surface, both of which are substantially parallel to a common central axis, a first end, a second end and a base perpendicular to the common axis and coupled to the second end;
a flange extending circumferentially from the outer wall surface adjacent to the first end, wherein the flange includes a perturbance extending outward from the flange parallel to the central axis wherein the cylindrical wall, flange and perturbance are unitarily formed from a single material; and
a semipermeable barrier positioned at and covering an interior surface of the base wherein the base, the second end of the wall and a portion of the semipermeable barrier interposed between the base and the second end of the wall, form an integrated gapless continuous unified structure and wherein the fluid extraction apparatus is replaceable as a unitary assembly.

2. The extraction apparatus of claim 1, wherein the base is coupled to an annular surface between the inner wall surface and the outer wall surface at the second end.

3. The extraction apparatus of claim 1, wherein the base includes a plurality of voids configured to allow unimpeded transmission of a filtrate through the semipermeable barrier.

4. The extraction apparatus of claim 1, wherein the perturbance extends symmetrically from the flange.

5. The extraction apparatus of claim 4, wherein the perturbance is configured to engage a first channel present in a first ferrule and a second channel present in a second ferrule.

6. The extraction apparatus of claim 5, further comprising a clamp configured to engage the first ferrule and the second ferrule compressing the perturbance within the first channel and the second channel respectively thereby forming a seal.

7. The extraction apparatus of claim 1, wherein the perturbance extends unilaterally from the flange.

8. The extraction apparatus of claim 7, wherein the perturbance is configured to engage a first channel present in a first ferrule.

9. The extraction apparatus of claim 8, further comprising a clamp configured to engage the first ferrule and a second ferrule compressing the perturbance within the first channel thereby forming a seal.

10. The extraction apparatus of claim 1, wherein the vessel is configured to accept one or more constituent filter media components so as to reside within the apparatus between an upper surface of the semipermeable barrier and the first end, said semipermeable barrier and filter media being adapted to accommodate a filtrate therethrough.

11. The extraction apparatus of claim 1, further comprising one or more constituent filter media components residing within the apparatus positioned between an upper surface of the semipermeable barrier and the first end, said semipermeable barrier and filter media being adapted to accommodate a filtrate therethrough.

12. The extraction apparatus of claim 1, wherein the semipermeable barrier is a membrane.

13. The extraction apparatus of claim 1, wherein the semipermeable barrier is a filter.

14. The extraction apparatus of claim 1, wherein the semipermeable barrier is planar.

15. The extraction apparatus of claim 1, wherein the semipermeable barrier is circular.

16. The extraction apparatus of claim 1, wherein the semipermeable barrier is a plant-based material.

17. The extraction apparatus of claim 1, wherein the semipermeable barrier is a synthetic based material.

18. (canceled)

19. The extraction apparatus of claim 1, wherein the fluid extraction apparatus is a right cylindrical vessel.

20. A system for fluid extraction, comprising:
a removable vessel having a wall with an inner wall surface and an outer wall surface, both of which are substantially parallel to a common central axis, a first end, a second end and a base perpendicular to the common axis and coupled to the vessel at the second end, wherein the vessel includes an flange extending circumferentially from an outer surface of the outer wall adjacent to the first end and wherein the flange includes a semi-rigid perturbance extending outward from the flange parallel to the central axis
a housing having a housing inner wall and a housing ferrule wherein the housing is sized to accept the removable vessel such that the housing inner wall is proximate to the outer wall surface of the vessel and wherein the housing ferrule is adjacent to and supports a lower surface of the flange of the vessel and is configured to accept a first portion of the semi-rigid perturbance;
an intake column having an intake column ferrule adjacent to an upper surface of the flange of the vessel and configured to accept a second portion of the semi-rigid perturbance; and
a clamp configured to compress the intake column ferrule, the housing ferrule and the flange of the vessel to form a seal.

21. The system of claim 20, wherein the vessel includes a semipermeable barrier positioned at and covering the base within the vessel wherein a portion of the semipermeable membrane is interposed between the base and the annular surface at the second end of the vessel.

22. The system of claim 20 wherein the vessel is configured to accept one or more constituent filter media components so as to reside within the vessel and between an upper surface of the semipermeable barrier and the first end, said semipermeable barrier and filter media being adapted to accommodate a filtrate therethrough.

23. The system of claim 20 wherein the base and the wall of the vessel form a unified structure and wherein the portion of the semipermeable barrier is integrated into the unified structure.
